(19) United States
(12) Patent Application Publication
(10) Pub. No.: US 2002/0066187 A1
(43) Pub. Date: Jun. 6, 2002

(54) Folding knife liner lock adjustment method and apparatus

(76) Inventor: Jeffrey L. Jennings, Oregon City, OR (US)

Correspondence Address: Jeffrey S. Gundersen, FOLEY & LARDNER, Firstar Center, 777 East Wisconsin Avenue, Milwaukee, WI, 53202-5367, US

(21) Appl. No.: 09/731,106

(22) Filed: Dec. 6, 2000

(51) Int. Cl. B26B 1/04

(52) U.S. Cl. 30/161; 30/155

(57) ABSTRACT

A folding knife with a blade, handle, and liner lock incorporates an eccentric adjustment mechanism to adjust the position of the liner lock during assembly such that the liner lock and the blade are properly positioned. The adjustment mechanism uses an eccentric nut or pin that imparts lateral motion on the liner lock when rotated during the assembly process. A method of assembling a folding knife includes using the adjustment mechanism during the assembly process to result in a snug fit between the liner lock and blade.

### FIELD OF THE INVENTION

The present invention relates generally to the field of folding knives. More particularly, the present invention relates to an adjustable liner lock for a folding knife.

### BACKGROUND OF THE INVENTION

Folding knives often use a locking mechanism to lock the blade in the opened position while in use such that the blade does not accidentally close, possibly harming the user of the knife. One such locking mechanism is known as a liner lock.

A liner lock typically has a spring arm that springs into position behind the opened blade, creating an interference with the blade tang such that the blade may not be rotated toward its folded position.

The spring arm must fit against the back of the blade such that it springs into position at the proper time, and does not allow play in the blade position when it is engaged. Therefore, during the initial assembly of the knife, the liner lock must be secured in the proper position. Due to component manufacturing tolerances, the relationship between the liner lock and the blade must be adjusted during the assembly of each knife such that the components interact properly.

Another important consideration is the alignment of the mating surfaces of the liner lock and blade. To ensure endurance and stability of the lock, the liner lock and blade must engage along a surface rather than at a point. This requires proper angular alignment of the liner lock and the blade such that the two components meet squarely across the surface of engagement. If one or both components is askew, the components will engage at a point rather than the surface. If this is the case, the liner lock can be prone to failure. Additionally, having a point of engagement increases wear on the liner lock because of the greater amount of stress on that point. Accordingly, it is desirable to maintain perfect parallelism between the liner lock and blade contact surfaces.

It is desired to have as much adjustment capability as possible in the liner lock to compensate for manufacturing tolerances. The more adjustment capability there is built into the knife, the wider the acceptable dimensional tolerance band.

Conventionally, adjustment of the liner lock during assembly has been done in numerous ways. First, the size of the liner lock and blade can be modified to create an acceptable fit by hand-grinding the components. This method is time consuming, increasing the cost of each knife. Second, the amount the blade opens can be controlled through the position of a stop that defines the blade's operative position. The position of the stop can be changed to correspond to the liner lock positioning, thus eliminating the play in the blade. This method creates a point of contact rather than a surface of engagement between the blade and liner lock because the operative angle of the blade changes with the position of the stop. Another method is to use stops of varying sizes. The stops are sorted such that one can be found that corresponds to the fit of each assembled knife. Again, this is a time consuming method of assembly.

Another method of adjusting the knife is to adjust the position of the blade through the use of an eccentric blade axle. This method also has numerous disadvantages. Because the blade tang must fit snugly on the axle to avoid play in the knife, the amount of possible lateral adjustment of the blade is limited. Additionally, the axle aperture in the blade must be circular in order for the blade to rotate on the axle without the tang moving off its axis of rotation. Therefore, the axle aperture may not be a slot. Because the axle aperture is round, the eccentric axle not only moves the blade laterally with respect to the liner lock and handle during adjustment, but the blade will also move vertically as the eccentric axle presses against the top and bottom of the axle aperture. A design that allows the blade to be moved vertically during adjustment throws off the alignment between the back of the tang and the liner lock, creating point contact rather than contact spread over two parallel surfaces. Again, point contact has a higher incidence of failure under shock impacts and pronged wear.

In view of the disadvantages of conventional folding knife liner locks, it would be advantageous to have a liner lock adjustment mechanism that permits adjustment of the liner lock without modifying the dimensions of the components during assembly. Further still, it would be advantageous to have a liner lock adjustment mechanism that allows a faster method of adjustment of the liner lock during assembly. Further, it would be advantageous to have a liner lock adjustment mechanism that maintains the parallelism of the blade and liner lock contact surfaces. Further still, it would be advantageous to have a liner lock adjustment mechanism that permits a maximum amount of lateral adjustment of the liner lock to allow greater component manufacturing tolerances.

### SUMMARY OF THE INVENTION

One embodiment of the invention relates to a folding knife including a handle having a front end and a back end. A blade is rotatably coupled to the handle by a blade axle. A liner lock is coupled to the handle. An eccentric adjustment mechanism is rotatably coupled to the liner lock and the handle at a point between the blade axle and the back end. The eccentric adjustment mechanism includes a first segment with a first axis of rotation and a second segment with a second axis of rotation. The first segment engages the handle and the second segment engages the liner lock. When the eccentric adjustment mechanism is rotated, the liner lock is moved with respect to the handle.

A further embodiment of the invention relates to a folding knife with a handle having a front end and a back end. A blade is rotatably coupled to the handle by a blade axle. A liner lock is coupled to the handle and has an aperture therethrough at a point distal the blade axle. An eccentric adjustment mechanism is rotatably coupled to the handle and the liner lock through the aperture. The eccentric adjustment mechanism includes a first segment with a first axis of rotation and a second segment with a second axis of rotation. The first segment engages the handle and the second segment engages the liner lock, whereby when the eccentric adjustment mechanism is rotated the liner lock is moved with respect to the handle.

A further embodiment of the invention relates to a folding knife with the handle having a first handle side and a second handle side. A blade is rotatably coupled to the handle by a blade axle, and a liner lock is coupled to the handle. An aperture is defined in the liner lock at a point distal the blade axle, and the aperture has a top, a bottom, a front, and a back. An eccentric adjustment mechanism is rotatably coupled to the handle and the liner lock through the aperture, and the eccentric adjustment mechanism includes a first segment with a first axis of rotation and a second segment with a second axis of rotation. The first segment engages the handle and the second segment engages the liner lock. When the eccentric adjustment mechanism is rotated, the liner lock is moved with respect to the handle. The aperture is sized such that the second segment does not make contact with the top or bottom when rotated.

A still further embodiment of the invention relates to a folding knife having a handle with a front end and a back end. A blade is rotatably coupled to the handle by a blade axle, and a liner lock is coupled to the handle. A notch is defined in the liner lock at an end distal the blade axle, and an eccentric adjustment mechanism is rotatably coupled to the handle. The eccentric adjustment mechanism includes a first segment with a first axis of rotation and a second segment with a second axis of rotation. The first segment engages the handle and the second segment engages the notch, whereby when the eccentric adjustment mechanism is rotated the liner lock is moved toward the front end.

A still further embodiment of the invention relates to a method of assembling a folding knife having a handle, a blade, a liner lock, and an eccentric adjustment mechanism. The method includes the steps of placing the blade into a first side of the handle, and placing the liner lock into the first side of the handle. The method further includes installing the eccentric adjustment mechanisms such that it is engaged with the liner lock, and opening the blade into its operative position. The method further includes adjusting the position of the liner lock by rotating the eccentric adjustment mechanism until the liner lock is snug against the blade.

### BRIEF DESCRIPTION OF THE DRAWINGS

An exemplary embodiment will hereafter be described with reference to the accompanying drawings, wherein like reference numerals denote like elements, and:

FIG. 1 is a exploded perspective view of a folding knife;

FIG. 2 is a perspective view of a handle side;

FIG. 3 is a side view of a liner lock;

FIG. 4 is a perspective view of an eccentric adjustment mechanism;

FIG. 5 is a sectional view of an eccentric adjustment mechanism;

FIG. 6 is an exploded perspective view of a folding knife according to a second embodiment;

FIG. 7 is a side view of a liner lock of the second embodiment; and

FIG. 8 is a perspective view of an eccentric adjustment mechanism of the second embodiment.

### DETAILED DESCRIPTION OF THE PREFERRED EMBODIMENTS

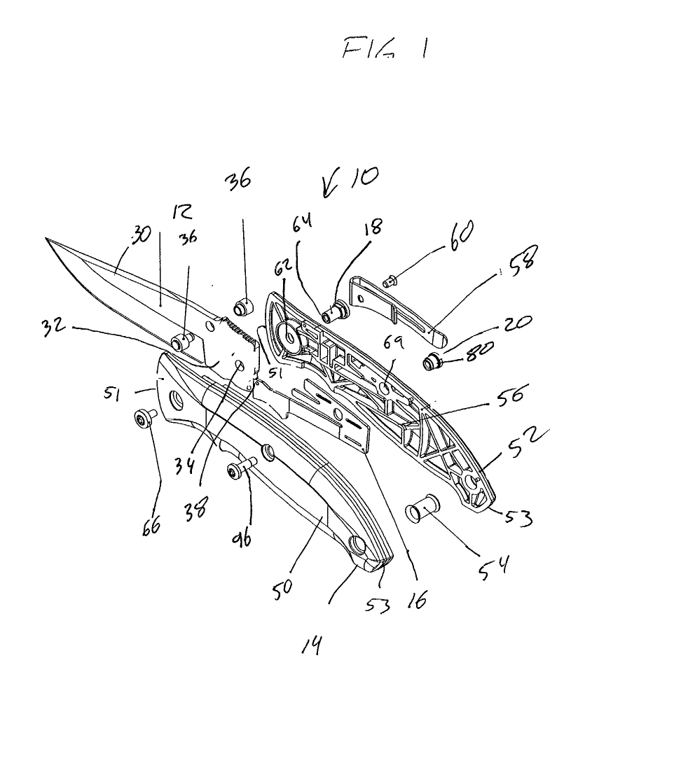

Referring to FIG. 1, a folding knife 10 includes a blade 12, a handle 14, and a liner lock 16. The blade 12 is rotatably coupled to the handle 14 by a blade axle 18. The liner lock 16 is disposed within the handle 14.

The blade 12 has a working portion 30 and a tang 32. The tang 32 has an aperture 34 that receives blade axle 18. A thumb stud 36 can be coupled to the blade 12 to function as a stopping mechanism to prevent further rotation of the blade 12 away from the handle 14 past the optimal operational configuration. When the blade 12 is in its operative position, a back surface 38 of the tang 32 rests against the liner lock 16.

The handle 14 has a first side 50 and a second side 52, each having a front 51 and a back 53. The two sides 50, 52 are attached by the blade axle 18 and a rear axle 54. An exemplary axle configuration is shown in FIG. 1 and can include a screw 66 that threads into a threaded bore in axle 18 such that the handle sides 50, 52 can be tightened together. The handle sides 50, 52 have a front aperture 62 that receives blade axle 18. A cavity 56 is configured to house both the liner lock 16 and the folded blade 12. A clip 58 can be attached to the handle 14 with a clip screw 60.

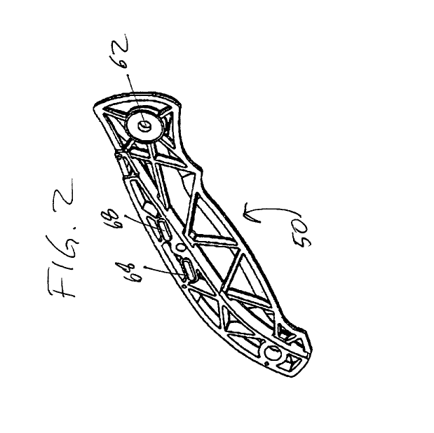

Referring to FIG. 2, the first handle side 50 can have a number of staking tabs 68 that extend orthogonally from the interior of the first handle side 50. The staking tabs 68 can be made of hard plastic or metal. Preferably, the staking tabs 68 are tapered such that they are wider at their base.

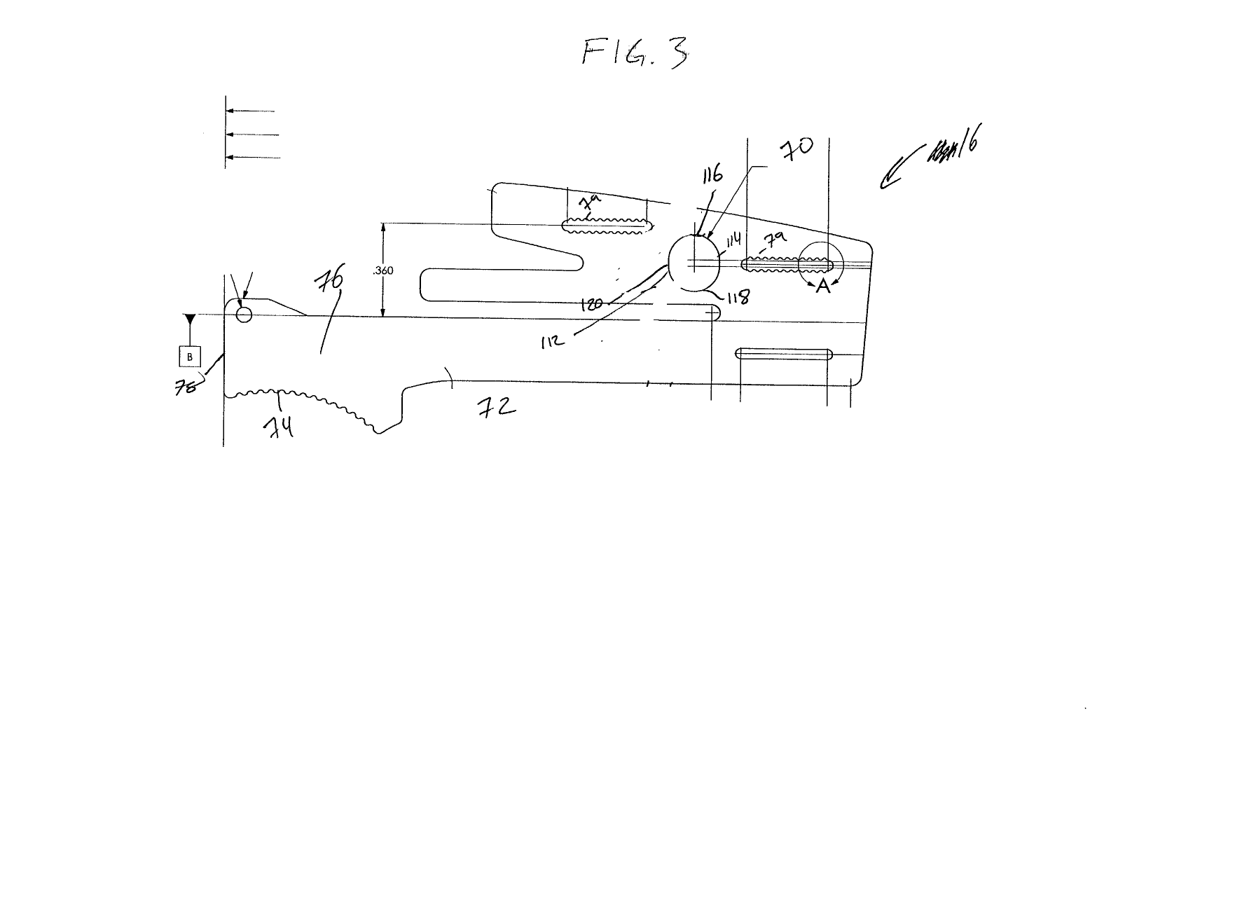

Referring to FIG. 3, the liner lock 16 has a spring arm 72 that locks the blade 12 into its operative position. A liner lock aperture 70 rotatably receives the eccentric adjustment mechanism 20 (FIG. 1). The spring arm 72 may have a serrated edge 74 designed to engage a user's thumb. A number of serrated tab slots 79 can extend along the face of the liner lock 16 in a direction parallel to the spring arm 72. The tab slots 79 are configured to receive the staking tabs 68.

The folding knife 10 has a first folded configuration wherein the blade 12 is housed within the handle 14. To place the folding knife 10 into its operative configuration, the blade 12 is rotated out from the handle 14. When the blade 12 is in its folded position within the handle 14, the spring arm 72 is deformed from its rest position as an end 76 of the spring arm 72 rides along the surface of the tang 32. As the blade 12 is rotated away from its folded configuration into its operative configuration, the end 76 rides along the tang 32 until the blade 12 has been rotated approximately 180 degrees such that the working portion 30 points away from the handle 14. When the blade 12 arrives at its operative position, the spring arm 72 snaps into position behind the tang 32. Once the spring arm 72 springs into position behind the tang 32, the blade 12 is prevented from rotating back toward its folded position. Thus the liner lock 16 locks the blade 12 into its operative position.

During assembly of the folding knife 10, the liner lock 16 is adjusted such that the spring arm 72 snaps into position behind the tang 32 at the proper moment. If the liner lock 16 is disposed too far toward the rear 53 of the handle 14, there will be a gap between a front surface 78 of the liner lock 16 and the back surface 38 of the tang 32, such that the blade 12 is loose in its operative position because it may be folded slightly toward its folded configuration before the spring arm 72 stops the travel of the blade 12.

If the liner lock 16 is disposed too close to the front 51 of the handle 14, the spring arm 72 may not spring into position behind the tang 32 when the blade 12 is in its operative position. This situation would prevent the blade 12 from being locked at all.

During assembly of the folding knife 10, the blade 12 is rotated into its operative position, and the liner lock 16 is adjusted such that the front surface 78 of the liner lock 16 is flush against the back surface 38 of the blade 12. The liner lock 16 is then secured into position with respect to the blade 12 and handle 14, insuring proper operation of the liner lock 16 after assembly.

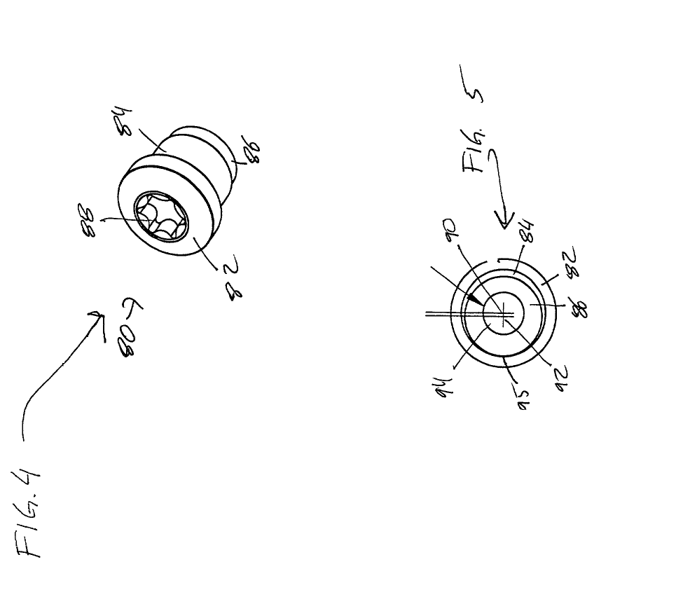

Referring to FIGS. 1 and 4 the eccentric adjustment mechanism 20 has an eccentric nut 80 and a bridge screw 96. The eccentric nut 80 has a head 82, a first associated rotational segment 84, and a second associated rotational segment 86.

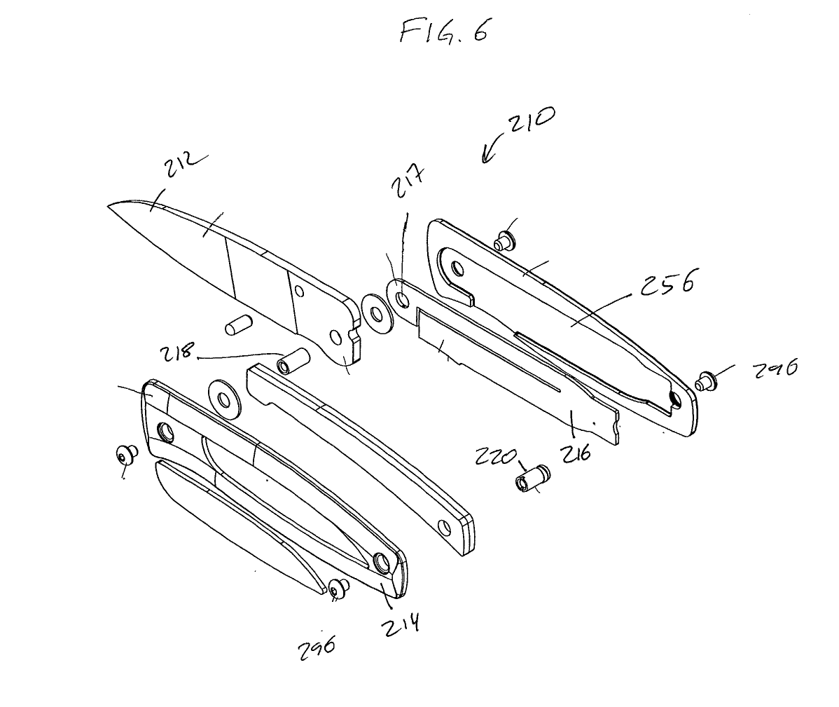

Referring to FIG. 5, the second rotational segment 86 has a center axis 92 that is offset from the center axis 90 of the first rotational segment 84. An extension point 95 defines the furthest extent the second segment 86 extends away from the axis of the first segment 94, defining the extent of possible adjustment. Thus, when the eccentric nut 80 is rotated, the second segment 86 rotates in an eccentric fashion because its axis of revolution is displaced from the center of revolution of the eccentric nut 80. Thus, the second segment 86 is able to impart reciprocating motion on a component with which it is engaged.

Referring to FIG. 1, the eccentric nut 80 is installed through an aperture 69 in handle side 52 such that the first rotational segment 84 rotates within the aperture 69 and the second rotational segment 86 engages the aperture 70 of the liner lock 16. When the eccentric nut 80 is rotated, the second rotational segment 86 imparts the reciprocating motion to the liner lock 16 such that rotating the eccentric nut 80 causes the liner lock 16 to move laterally within the handle 14. It is in this fashion that the liner lock 16 can be adjusted during assembly of the knife 10.

Referring to FIG. 4, the head 82 of the eccentric nut 80 has a head recess 88 designed to accept a tool used to rotate the eccentric nut 80. Alternatively, the eccentric nut 80 can be rotated by hand.

Referring to FIG. 1, a bridge screw 96 is used to secure the eccentric nut 80. The bridge screw is inserted into handle side 50, and threads into a corresponding bore 94 (FIG. 5) in the eccentric nut 80. Thus, after the eccentric nut 80 has been rotated to adjust the liner lock 16, the bridge screw 96 is threaded into the eccentric nut 80, securing the final liner lock 16 orientation.

Referring to FIG. 3, in an exemplary embodiment, the aperture 70 has a vertical diameter that is greater than the diameter of the second segment 86 that engages the aperture 70. Therefore, when the eccentric nut 80 is rotated, the second segment 86 does not make contact with either a top side 116 or bottom side 118 of the aperture 70. This configuration prevents vertical travel of the liner lock 16 during the adjustment process.

Additionally, in an exemplary embodiment, while a front side 112 of the aperture 70 has a flattened portion 120, the back side 114 of the aperture 70 does not. Therefore, the second segment 86 only makes contact with the front side 112 of the aperture 70 when the eccentric nut 80 is rotated. Accordingly, lateral motion of the liner lock is imparted by the second rotational segment 86 in the direction of the blade 12 when the eccentric nut 80 is rotated but the liner lock 16 does not move vertically, which would disturb the alignment between the front surface 78 and back surface 38.

Referring to FIG. 1, the folding knife 10 is assembled in the following fashion. The blade axle 18 and the eccentric nut 80 are inserted into the second handle side 52. The liner lock 16 is then installed within the cavity 56 of the second handle side 52. Next the blade 12 is installed on the blade axle 18. The first handle side 50 can then be loosely secured to the second handle side 52 by threading on the axle screw 66 and the bridge screw 96. The axle screw 66 can then be tightened until it is snug, removing play in the blade 12 but still allowing the blade 12 to be rotated on the blade axle 18. The blade is then opened to its fully operative position such that the spring arm 72 springs into locked position behind the tang 32.

A key wrench is then inserted into the head recess of the eccentric nut 80 and the nut 80 is rotated to press the liner lock 16 into proper engagement with the blade 12. When the liner lock 16 has been adjusted such that the front surface 78 is flush against the blade back surface 38, the bridge screw 96 is tightened into the eccentric nut 80 without further rotating the eccentric nut. To ensure the position of the liner lock 16 is maintained, a thread locking agent is placed on both the threads of the eccentric nut 80 and the bridge screw 96 prior to installation such that after tightening the two components together, the nut 80 and bridge screw 96 do not come apart.

When the eccentric nut 80 and the bridge screw 96 are tightened, bringing the handle sides 50, 52 together, the staking tabs 68 (FIG. 2) will fully engage the tab slots 79 (FIG. 3). The engagement between the staking tabs 68 and the tab slots 79 inhibit further movement of the liner lock 16.

In addition to using an adhesive, the eccentric nut 80 can be installed such that any pressure by the liner lock 16 back on the eccentric adjustment mechanism 20 will result in a tightening of the threads between the nut 80 and bridge screw 96. If the nut is rotated clockwise (from the perspective of FIG. 5) during the adjustment, then the extension point 95 will necessarily be disposed below the lateral centerline of the eccentric nut 80 after the adjustment (because, above the centerline, the extension point 95 will retreat from the direction of the blade 12, loosening the fit between the liner lock 16 and the blade 12). Because the extension point 95 is below the centerline, back pressure on the second segment 86 by the liner lock 16 will tend to rotate the nut 80 counter-clockwise, tightening the right-handed threads securing the nut 80 to the bridge screw 96.

The exemplary embodiment that allows adjustment in the forward direction but not in the reverse direction prevents a situation wherein the assembler rotates the eccentric adjustment mechanism 80 in a direction that moves the liner lock 16 away from the blade 12. If the liner lock 16 hangs up on the handle 14 or the serrated tabs 79, the assembler could mistakenly believe that the fit between the blade 12 and the liner lock 16 is snug, resulting in an assembled knife that does not function properly.

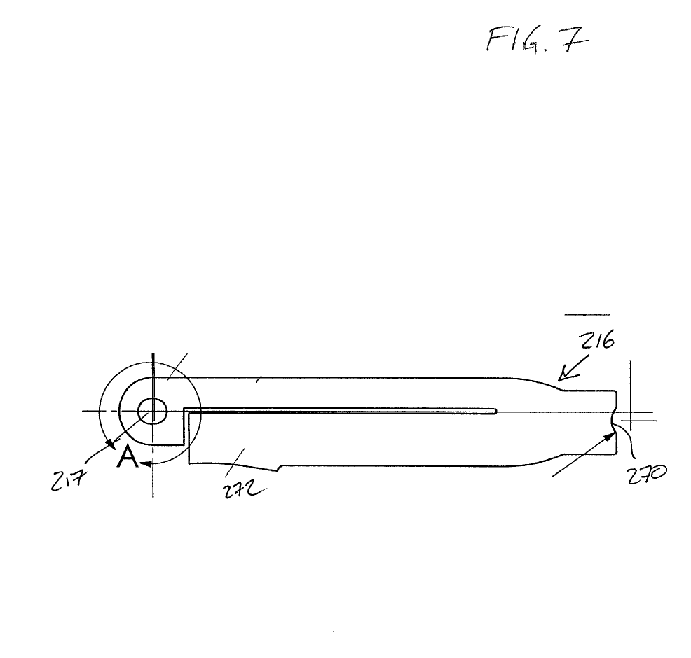

Referring to FIG. 6, a second embodiment of a folding knife 210 is shown. In the second embodiment, the liner lock 216 has a forward aperture 217, through which a blade axle 218 travels. A blade 212 and handle 214 are not substantially altered in the second embodiment of the folding knife 210 except that the liner lock 216 is designed to fit into a smaller cavity 256 in the handle 214.

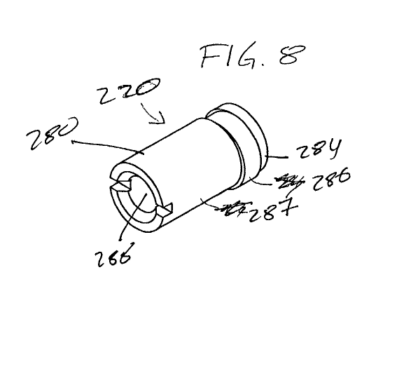

Referring to FIG. 7, the liner lock 216 has a spring arm 272 and a eccentric adjustment notch 270. The forward aperture 217 is a slot, with its long axis parallel to the spring arm 272.

Referring to FIG. 8, an eccentric adjustment mechanism 220 is shown. The eccentric adjustment mechanism is shown as an axle 280 with a first rotational segment 284, a second rotational segment 286, and a third rotational segment 287. A threaded recess 288 can extend into either end of the eccentric axle 280. The second rotational segment 286 has an axis of rotation that is offset from that of the first and third rotational segments 284, 287. Therefore, when the axle 280 is rotated, the second rotational segment 286 will impart reciprocating motion.

When installed in the folding knife 210, the second rotational segment 286 engages the eccentric adjustment notch 270. Accordingly, when the second rotational segment 286 is rotated, the liner lock 216 can be pushed forward toward the blade 212. In this manner, the liner lock 216 is adjusted during the assembly process to create the ideal fit against the blade 212 as discussed for the first embodiment.

Once the final position of the liner lock 216 is set, the axle 280 rotational position is set by threading screws 296 (FIG. 6) into the recesses 288. The notch 270 is sized such that the liner lock 216 does not rotate during adjustment, but moves laterally so as not to disturb the parallelism between liner lock 216 and blade 212 contact surfaces. The aperture 217 also helps prevent liner lock 216 rotation, while allowing lateral motion.

While several embodiments of the invention have been described, it should be apparent to those skilled in the art that what has been described is considered at present to be the preferred embodiments of an a folding blade knife and method of assembling a folding blade knife. However, changes can be made in the design without departing from the true spirit and scope of the invention. The following claims are intended to cover all such changes and modifications which fall within the true spirit and scope of the invention.

What is claimed is:

1. A folding knife, comprising:
a handle having a front end and a back end;
a blade rotatably coupled to the handle by a blade axle;
a liner lock coupled to the handle;
an eccentric adjustment mechanism rotatably coupled to the liner lock and the handle at a point between the blade axle and the back end, the eccentric adjustment mechanism including a first segment with a first axis of rotation and a second segment with a second axis of rotation;
wherein the first segment engages the handle and the second segment engages the liner lock;
whereby when the eccentric adjustment mechanism is rotated the liner lock is moved with respect to the handle.

2. The folding knife of claim 1, wherein the eccentric adjustment mechanism is an eccentric nut.

3. The folding knife of claim 2, wherein the eccentric nut has a head.

4. The folding knife of claim 3, further comprising:
a bridge screw;
wherein the eccentric nut has a recess configured to receive the bridge screw; and
wherein the bridge screw is threaded into the eccentric nut.

5. The folding knife of claim 4, wherein the eccentric nut and bridge screw are configured such that pressure on the liner lock in a direction away from the front end results in a tightening of the bridge screw and eccentric nut.

6. A folding knife, comprising:
a handle having a front end and a back end;
a blade rotatably coupled to the handle by a blade axle;
a liner lock coupled to the handle, the liner lock having an aperture therethrough at a point distal the blade axle;
an eccentric adjustment mechanism rotatably coupled to the handle and the liner lock through the aperture, the eccentric adjustment mechanism including a first segment with a first axis of rotation and a second segment with a second axis of rotation;
wherein the first segment engages the handle and the second segment engages the liner lock;
whereby when the eccentric adjustment mechanism is rotated the liner lock is moved with respect to the handle.

7. The folding knife of claim 6, wherein the eccentric adjustment mechanism engages a forward side of the aperture during rotation, but not a rearward side of the aperture.

8. The folding knife of claim 6, wherein the eccentric adjustment mechanism is an eccentric nut.

9. The folding knife of claim 8, wherein the eccentric nut has a head.

10. The folding knife of claim 9, further comprising:
a bridge screw; and
a recess in the eccentric nut configured to receive the bridge screw, wherein the bridge screw is threaded into the recess.

11. The folding knife of claim 10, wherein the eccentric nut and bridge screw are configured such that pressure on the liner lock in a direction away from the front end results in a tightening of the bridge screw and eccentric nut.

12. A folding knife, comprising:
a handle having a first handle side and a second handle side;
a blade rotatably coupled to the handle by a blade axle;
a liner lock coupled to the handle;
an aperture defined in the liner lock at a point distal the blade axle, the aperture having a top, a bottom, a front, and a back;
an eccentric adjustment mechanism rotatably coupled to the handle and the liner lock through the aperture, the eccentric adjustment mechanism including a first segment with a first axis of rotation and a second segment with a second axis of rotation;
wherein the first segment engages the handle and the second segment engages the liner lock;
whereby when the eccentric adjustment mechanism is rotated, the liner lock is moved with respect to the handle;
wherein the aperture is sized such that the second segment does not make contact with the top or the bottom when rotated.

13. The folding knife of claim 12, further comprising:
a plurality of slots defined in the liner lock; and
a plurality of staking tabs extending from one of the handle sides into the slots, wherein the staking tabs inhibit movement of the liner lock after the first and second handle sides are tightened together.

14. The folding knife of claim 13, wherein the slots are serrated.

15. The folding knife of claim 12, wherein the second segment engages the front of the aperture during rotation, but not the back of the aperture.

16. The folding knife of claim 12, wherein the eccentric adjustment mechanism is an eccentric nut.

17. The folding knife of claim 16 wherein the eccentric nut has a head.

18. The folding knife of claim 17, further comprising: a bridge screw;
wherein the eccentric nut has a recess configured to receive the bridge screw; and
wherein the bridge screw is threaded into the eccentric nut.

19. The folding knife of claim 18, wherein the eccentric nut and bridge screw are configured such that pressure on the liner lock in a direction away from the opened blade results in a tightening of the bridge screw and eccentric nut.

20. A folding knife, comprising:
a handle having a front end and a back end;
a blade rotatably coupled to the handle by a blade axle;
a liner lock coupled to the handle;
a notch defined in the liner lock at an end distal the blade axle;
an eccentric adjustment mechanism rotatably coupled to the handle, the eccentric adjustment mechanism including a first segment with a first axis of rotation and a second segment with a second axis of rotation;
wherein the first segment engages the handle and the second segment engages the notch;
whereby when the eccentric adjustment mechanism is rotated the liner lock is moved toward the front end.

21. The folding knife of claim 20, wherein the blade is rotatably coupled to the handle via a blade axle, and wherein the liner lock is coupled to the blade axle.

22. The folding knife of claim 20, wherein the eccentric adjustment mechanism is a pin.

23. The folding knife of claim 22, wherein the pin has two threaded recesses, each configured to receive a screw.

24. A method of assembling a folding knife having a handle, a blade, a liner lock, and an eccentric adjustment mechanism, comprising the steps of:
placing the blade into a first side of the handle;
placing the liner lock into the first side of the handle;
installing the eccentric adjustment mechanism such that it is engaged with the liner lock;
opening the blade into its operative position; and
adjusting the position of the liner lock by rotating the eccentric adjustment mechanism until the liner lock is snug against the blade.

25. The method of assembling a folding knife of claim 24, further comprising the steps of:
providing a fastener; and
securing the rotational position of the eccentric adjustment mechanism with the fastener.

26. The method of assembling a folding knife of claim 24, wherein the handle has a second side, further comprising the step of:
fastening the first side to the second side with a plurality of fasteners.

27. The method of assembling a folding knife of claim 24, wherein the liner lock has a plurality of slots, and the handle has a plurality of staking tabs; and further comprising the step of tightening the handle sides together such that the staking tabs extend into the slots, fixing the location of the liner lock.
